(19) United States
(12) Patent Application Publication
(10) Pub. No.: US 2023/0324221 A1
(43) Pub. Date: Oct. 12, 2023

(54) LIGHT DETECTION DEVICE FOR ALERTING AN EXTERNAL MONITORING SYSTEM

(71) Applicant: New York Blood Center, Inc., New York, NY (US)

(72) Inventor: Benjamin Matthew Bloomquist, Vadnais Heights, MN (US)

(21) Appl. No.: 18/299,454

(22) Filed: Apr. 12, 2023

Related U.S. Application Data
(60) Provisional application No. 63/330,161, filed on Apr. 12, 2022.

(51) Int. Cl. G01J 1/44

(52) U.S. Cl. CPC G01J 1/44

(57) ABSTRACT

A light detection device for alerting an external monitoring system is disclosed herein. In an example, a photosensor apparatus is configured to use one or more photosensors to detect when light is emitted from an indicator lamp of a laboratory instrument. An output from the photosensor(s) is configured to cause a change in a relay switch, which sends a signal to a processor of a system monitor, which may be communicatively coupled to a network. After receiving a signal, the processor is configured to cause the system monitor to generate an alert or alarm indicative that at least one platelet sample within the laboratory instrument has tested positive for bacteria. The system monitor may display the alert or alarm via a user interface and/or may transmit one or more messages to client devices indicative of the light illumination.

### PRIORITY CLAIM

This application claims priority to and the benefit as a non-provisional application of U.S. Provisional Patent Application No. 63/330,161, filed Apr. 12, 2022, the entire contents of which are hereby incorporated by reference and relied upon.

### BACKGROUND

Worldwide about millions of platelets are donated yearly. Before donated platelets can be used, a sample of the donation is screened for bacteria. To accomplish this, culture bottles of platelets are loaded into a laboratory instrument that performs microbial detection. Culture bottles that test positive for bacteria are sent to an independent laboratory for identification and the corresponding donated platelets are discarded.

Oftentimes, the laboratory instruments that perform the cultures are not interoperable with external monitoring systems. To indicate a sample has tested positive for bacteria, the laboratory instrument includes indicator lights that are viewable by operators within close proximity of the instrument. Detection of bacteria causes the laboratory instrument to activate a light, which provides a visible cue to the operator that the system needs attention. Given the required duration of platelet incubation, instruments are in operation twenty-four hours a day and seven days a week, which means that at least one operator has to be present and in close proximity to the instrument to monitor when an indicator light is activated.

### SUMMARY

The present disclosure provides a new and innovative system, method, and apparatus for detecting when a light from a laboratory instrument is activated. The system, method, and apparatus are configured to use a photosensor to detect when the light is illuminated. An output from the photosensor is configured to cause a change in a relay switch, which sends a signal to a processor of a system monitor, which may be communicatively coupled to a network. After receiving a signal, the processor is configured to cause the system monitor to generate an alert or alarm indicative that at least one platelet sample has tested positive for bacteria. The system monitor may display the alert or alarm via a user interface and/or may transmit one or more messages to client devices indicative of the light illumination. The disclosed system, method, and apparatus accordingly overcome the lack of interoperability of certain blood analyzer laboratory instruments by using a photosensor that is coupled to a system monitor to bridge the communication gap and allow instruments to be monitored in another location of a building or remotely.

The example system, method, and apparatus also include hardware that compensates for flashing amber or orange lights from the laboratory instrument indictor light. In some embodiments, at least two photoresistors are connected in parallel for detecting amber or orange lights illuminated by one or more indicator lights. Activation of the photoresistors in response to detecting light causes the disclosed hardware to change the state of a relay, which generates the alert or alarm signal discussed above. The photoresistors are electrically coupled to one or more capacitors and one or more transistors. The configuration of the capacitor(s) and transistor(s) in addition to resistors and diodes provides a smoothing or compensation function that keeps the relay in the changed position even when the indicator light is blinking (or temporarily off). Such a configuration prevents the transmission of periodic alert or alarm signals, which may cause multiple alerts or alarms to be generated for each instance of an alert or alarm signal. Alternatively, the periodical transmission of alert or alarm signals might be filtered or disregarded by the processor of the monitoring system. The compensation for indicator light flashing accordingly ensures a single alert or alarm is generated when a laboratory instrument detects bacteria in a platelet sample.

In light of the disclosure set forth herein, and without limiting the disclosure in any way, in a first aspect of the present disclosure, which may be combined with any other aspect, or portion thereof, described herein a photosensor apparatus includes a voltage source and a relay including a coil having an input end and an output end, and a switch connected to the voltage source or a separate voltage source and configured to switch between an open state and a closed state. The photosensor apparatus also includes at least one photoresistor or multiple photoresistors connected in parallel with each other, an input lead of each photoresistor being connected to the voltage source. The photosensor apparatus further includes a first transistor including a first collector or a first source connected to output leads of the photoresistors, a first base or a first gate connected to a first resistor, which is connected to the output leads of the photoresistors, and a first emitter or a first drain that is connected to a second resistor and a third resistor, and a second transistor including a second collector or a second source connected to the output end of the relay coil, a second base or a second gate connected to the second resistor, and a second emitter or a second drain that is connected to a ground. Additionally, the photosensor apparatus includes a capacitor comprising a first end connected to the output leads of the photoresistors and a second end connected to the ground or a different ground. The photoresistors are configured to detect constant or flashing light from an indicator lamp of a laboratory instrument and the combination of the first transistor, the second transistor, and the capacitor are configured to cause the switch of the relay to stay in the closed state when the constant or flashing light is detected.

In a second aspect of the present disclosure, which may be combined with any other aspect, or portion thereof, described herein, the relay is configured to output an alert signal in the closed state. The output signal is transmitted to a processor of a monitoring system, causing the processor to display an alert or an alarm to an operator.

In a third aspect of the present disclosure, which may be combined with any other aspect, or portion thereof, described herein, the photosensor apparatus further includes a circuit board including a power connector that is electrically connected to the voltage source, the relay, the first transistor, the second transistor, and the capacitor, a first wire connected to the power connector via the circuit board and to the input lead(s) of the photoresistor(s), and a second wire connected to a node at the circuit board and respectively to the output lead(s) of the photoresistor(s). The node at the circuit board is connected to the first collector or the first source of the first transistor and the first resistor.

In a fourth aspect of the present disclosure, which may be combined with any other aspect, or portion thereof, described herein, the photosensor apparatus further includes a light control tube configured to enclose at least portions of the first wire, at least portions of the second wire, and the photoresistor(s). The light control tube has an open end configured to be placed adjacent to the indicator light of the laboratory instrument for receiving the flashing or constant light.

In a fifth aspect of the present disclosure, which may be combined with any other aspect, or portion thereof, described herein, an opposite end of the second resistor is connected to an anode of a light emitting diode, and a cathode of the light emitting diode is connected to the ground or a separate ground.

In a sixth aspect of the present disclosure, which may be combined with any other aspect, or portion thereof, described herein, a first diode is connected between the voltage source and the at least one photoresistor or multiple photoresistors, and an anode of a second diode is connected to the second collector or the second source of the second transistor and a cathode of the second diode is connected to the input end of the relay.

In a seventh aspect of the present disclosure, which may be combined with any other aspect, or portion thereof, described herein, the capacitor is a polarized capacitor.

In an eighth aspect of the present disclosure, which may be combined with any other aspect, or portion thereof, described herein, the voltage source is between 5 volts and 12 volts and the capacitor has a value of 1 k uF.

In a ninth aspect of the present disclosure, which may be combined with any other aspect, or portion thereof, described herein, the first and second transistors are bipolar junction transistors (“BJTs”) or metal-oxide-semiconductor field-effect transistor (“MOSFETs”).

In accordance with an aspect of the present disclosure, any of the structure and functionality illustrated and described in connection with FIGS. 1 to 7 may be used in combination with any of the structure and functionality illustrated and described in connection with any of the other of FIGS. 1 to 7 and with any one or more of the aspects disclosed herein.

In light of the aspects above and the disclosure herein, it is accordingly an advantage of the present disclosure to provide a system that bridges a communication gap between a laboratory instrument by detecting an illumination state of an indicator light and alarm/alert monitoring system.

It is another advantage of the present disclosure to provide remote indications of an alert or alarm from a laboratory instrument using a photosensor apparatus.

It is a further advantage of the present disclosure to provide remote monitoring of donated platelets undergoing testing by a laboratory instrument for possible bacteria.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1 is a diagram of a light detection system, according to an example embodiment of the present disclosure.

FIG. 2 is a diagram of an indicator light of a laboratory instrument, according to an example embodiment of the present disclosure.

FIG. 3 is a diagram of a light control tube that is placed adjacent to or in proximity to an indicator light, according to an example embodiment of the present disclosure.

FIG. 4 is a diagram of a light sensing circuit, according to an example embodiment of the present disclosure.

FIG. 5 is a diagram of an alternative light sensing circuit, according to an example embodiment of the present disclosure.

FIG. 6 is a diagram of a user interface displaying an alert/alarm indicative that an indicator light of a laboratory instrument is illuminated, according to an example embodiment of the present disclosure.

FIG. 7 illustrates a flow diagram showing an example procedure for using a photosensor apparatus to detect an illumination state of an indicator light, according to an example embodiment of the present disclosure.

### DETAILED DESCRIPTION

The present disclosure relates in general to a method, apparatus, and system for detecting light for alerting or alarming an external monitoring system. Light from an indicator lamp is detected using a plurality of photoresistors connected in parallel with each other. Light detection causes a resistance of the photoresistors to decrease, thereby enabling current to flow through a monitoring circuit. A relay (or switch) of the monitoring circuit is configured to switch or actuate from an open state to a closed state (or vice versa) when the photoresistors detect light. The monitoring circuit includes transistors and one or more capacitors that are configured to filter or smooth a voltage across the relay, enabling the relay to stay in the changed state even when the detected light is blinking or flickering. The relay outputs an alert or alarm signal in the changed state. The alarm signal is used to indicate to a separate monitoring system that the indicator light is illuminated. The method, apparatus, and system accordingly provide a constant alert or alarm signal despite any fluctuations with the illuminated light.

The method, apparatus, and system are configured to bridge a communication gap between a laboratory analyzer and a monitoring system. In some instances, a laboratory analyzer may not be configured for interoperability with separate monitoring systems. For instance, a laboratory instrument may be configured in a first protocol while a monitoring system is configured with a second, different protocol that prevents the laboratory instrument from communicating with the monitoring system via a network or serial connection.

The method, apparatus, and system bridge the communication gap by taking advantage of a light output of the laboratory instrument. Oftentimes, known laboratory instruments include a status light (e.g. a green light, an orange/amber light, and a red light). The laboratory instrument is configured to switch from a green light to an orange/amber or red light when an alert or alarm is generated, such as when a platelet sample tests positive for bacteria. The method, apparatus, and system are configured to detect the illumination of the orange/amber light and/or the red light and output a corresponding alert or alarm signal to the monitoring system. The method, apparatus, and system accordingly enable a laboratory instrument to be monitored remotely even when a communication connection with a monitoring system is not possible.

Reference is made throughout to laboratory instruments and detecting a light status of such instruments. The laboratory instrument may be located in settings including but not limited to a blood donation processing center or a medical center. It should be appreciated that the method, apparatus, and system may be applied to any device that has a status or indicator light, such as power systems, process control systems, industrial systems, manufacturing systems, queue systems, first responder systems, military systems, and/or residential security systems.

### Light Detection System

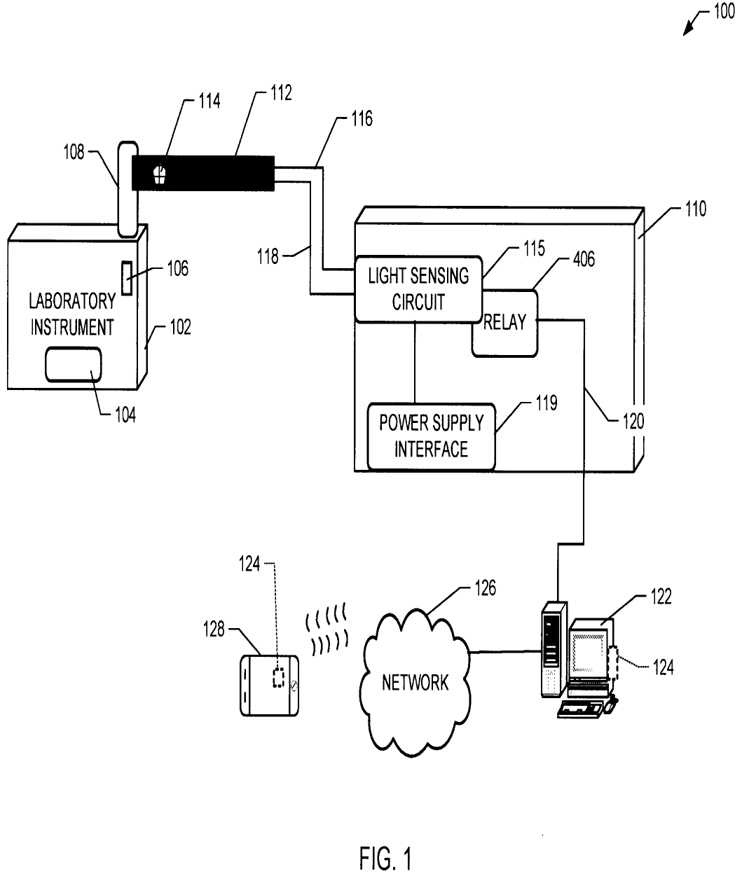

FIG. 1 is a diagram of a light detection system 100, according to an example embodiment of the present disclosure. The light detection system 100 includes at least one laboratory instrument 102. In some embodiments, the laboratory instrument 102 is the BACT/ALERT® VIRTUO Microbial Detection System. It should be appreciated that while FIG. 1 shows the single laboratory instrument 102, the system 100 may include multiple laboratory instruments.

The laboratory instrument 102 includes a sample analysis receptacle 104 that is configured to receive one or more containers, cuvettes, or vials of a fluid sample, such as a platelet sample. The laboratory instrument 102 includes components for analyzing the containers from the sample analysis receptacle 104. The components may include pipettes for adding one or more reagents, incubation devices, a centrifuge for sample separation/concentration, and camera/sensors for measuring sample reactions with reagents.

A processor 106 of the laboratory instrument 102 is configured to analyze samples placed in the sample analysis receptacle 104 for one or more analytes. In the illustrated example, the laboratory instrument 102 analyzes platelet samples for the presence of certain bacteria. In other embodiments, the laboratory instrument 102 may analyze a blood sample (or urine sample) for the presence of one of more chemicals, drugs, biologics, etc.

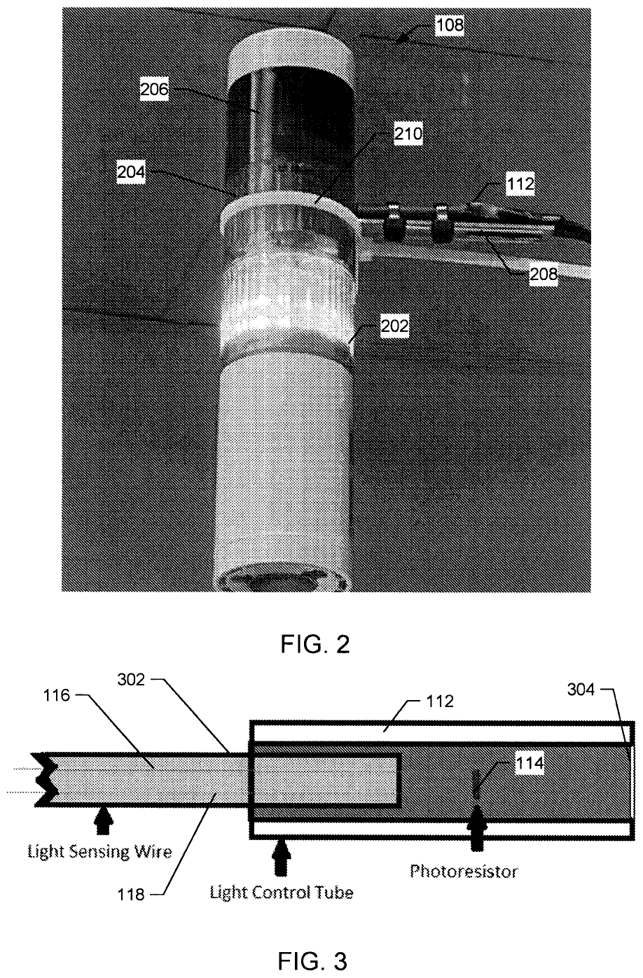

The laboratory instrument 102 also includes an indicator status lamp 108. FIG. 2 is a diagram of an indicator lamp 108 of the laboratory instrument 102, according to an example embodiment of the present disclosure. The indicator lamp 108 includes three lights to indicate a different status of the instrument. For example, a green light 202 is illuminated by the processor 106 to indicate a normal operating status. An orange/amber light 204 is illuminated by the processor 106 to indicate a warning status. A red light 206 is illuminated by the processor 106 to indicate an alarm status. The processor 106 may be configured to illuminate the amber light 204 when at least one sample tests positive for a certain analyte, such as bacteria.

Returning to FIG. 1, the light detection system 100 also includes a photosensor apparatus 110 that is configured to detect when one or more lights of the indicator lamp 108 are illuminated. The photosensor apparatus 110 includes a light control tube 112 that is configured to be connected or placed in proximity to the indicator light 108. As shown in FIG. 2, the light control tube 112 includes an opaque rubber, plastic, or heat-shrink material that is supported by an L-bracket 208 and held in place by a zip-tie 210. In other embodiments, the light control tube 112 may be placed adjacent to the indicator light 108 using other brackets and/or connectors.

As shown in FIG. 1, the light control tube 112 includes one or more photoresistors 114 that are connected to a light sensing circuit 115 of the photosensor apparatus 110 via a first wire 116 and a second wire 118. In some embodiments, two or more photoresistors 114 are used. In these embodiments, the first wire 116 and the second wire 118 provide a voltage potential across each of the two or more photoresistors 114. Alternatively, two or more photoresistors 114 are used where separate first wires and separate second wires are connected respectively to each photoresistor 114.

FIG. 3 is a diagram of the light control tube 112 that is placed adjacent to or in proximity to the indicator light 108, according to an example embodiment of the present disclosure. The light control tube 112 receives the first wire 116 and the second wire 118 from the light sensing circuit 115. The wires 116 and 118 may be provided in a wire housing 302, such as an insulating shield. Ends of the wires 116 and 118 are connected to opposite ends of at least one photoresistor 114. In some embodiments, the wires 116 and 118 are connected to opposite ends of two or four photoresistors 114.

The photoresistor(s) 114 are located inside of the light control tube 112. In some embodiments, the photoresistor(s) 114 are placed between one to four inches within the light control tube 112 from an open end 304 to prevent ambient light from being detected. The configuration shown in FIG. 3 enables the photoresistor(s) 114 to detect light emitted from only the indicator light 108.

Returning to FIG. 1, the light sensing circuit 115 is configured to process a voltage potential across the first and second wires 116 and 118 for detecting amber/orange light illuminated by the indicator lamp 108. When no light (or minimal light) is detected, the photoresistor(s) 114 are configured to have a resistance that is on the order of mega-ohms, thereby operating like an open switch. When amber/orange light is received, the photoresistor(s) 114 are configured to decrease in resistance, thereby closing a current path of the light sensing circuit 115. The resistance of the photoresistor(s) 114 may decrease from mega-ohms to kilo-ohms, which enables sufficient current to flow.

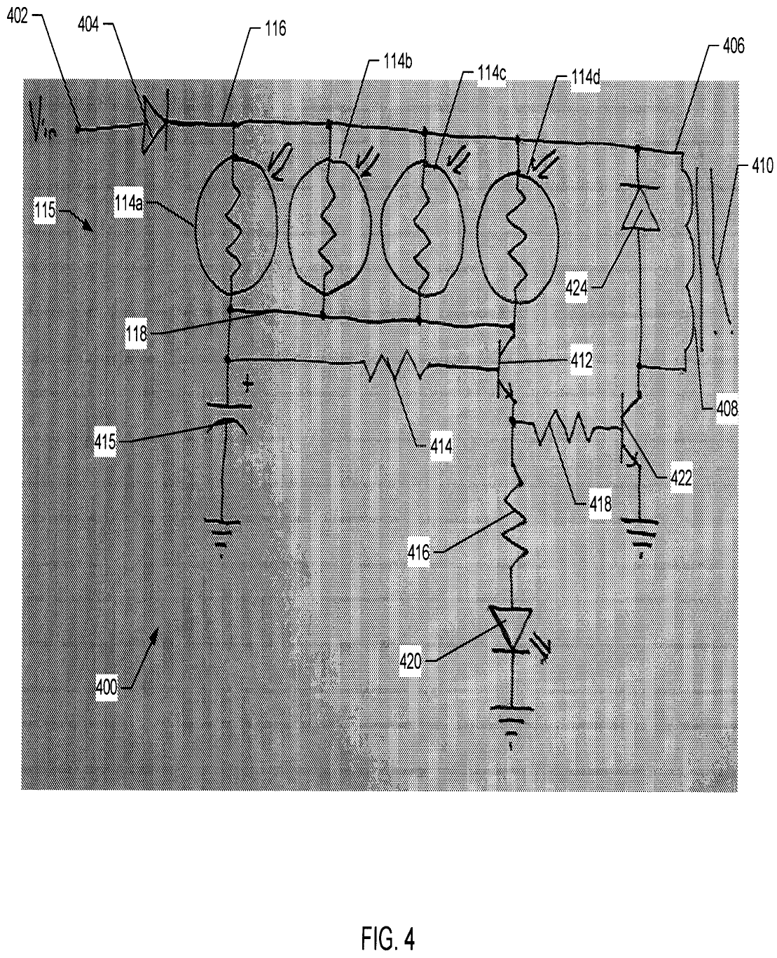

FIG. 4 is a diagram of the light sensing circuit 115, according to an example embodiment of the present disclosure. The light sensing circuit 115 may be implemented/mounted on a circuit board 400, which includes a power connector 402 that is electrically connected to a voltage source. The power connector 402 may include a connection to a voltage regulator that converts AC voltage into a DC voltage between 3.3 and 12 volts, preferably 5 volts. In FIG. 1, the voltage regulator is shown as a power supply interface 119, which is connected to an external power source, such as a wall outlet. In other embodiments, the power supply interface 119 may include a connection to a battery. The light sensing circuit 115 of FIG. 4 may include a diode 404 with an anode connected to the power connector 402 and a cathode connected to a node that connects to the first wire 116 for electrical coupling to a first side (e.g., an input lead) of the photoresistor(s) 114. The diode 404 provides a voltage drop from the power source and may prevent current spikes (from a relay 406) from reaching the power source.

The example relay 406 (or switch) of the light sensing circuit 115 includes a coil 408 and a switch 410. An input end of the coil 408 is electrically connected to the cathode of the diode 404. The switch 410 of the relay 406 may be electrically connected to the cathode of the diode 404 or may be connected to a separate circuit. The switch 410 is configured to actuate between an open state and a closed state. In the open state, the switch 410 causes voltage to be provided on a signal line 120 from the photosensor apparatus 110 to a system monitor 122 (as shown in FIG. 1). The voltage on the signal line 120 provides an alert or alarm signal to the system monitor 122.

Returning to FIG. 4, the light sensing circuit 115 includes a first transistor 412, which may include a bipolar junction transistor (“BJT”) or a metal-oxide-semiconductor field-effect transistor (“MOSFET”). A collector or a source of the transistor 412 is connected to a node on the circuit board 400 for the second wire 118. In other words, the collector or source is electrically connected to output leads of the photoresistor(s) 114. A base or gate of the transistor 412 is connected to a resistor 414, which is connected to the output leads of the photoresistor(s) 114 via the circuit board 400 and the second wire 118. The resistor 414 may have a value of 22 kilo-ohms, for example. The end of the resistor 414 is also connected to a capacitor 415, which has a first end connected to the output leads of the photoresistor(s) 114 via the circuit board 400 and the second wire 118. A second end of the capacitor 415 is connected to a ground. In some embodiments, the capacitor 415 is a polarized capacitor and may have a value of 1 k uF.

An emitter or drain of the transistor 412 is connected to resistors 416 and 418. An opposite end of the resistor 416 is connected to a light emitting diode 420, which has a cathode connected to the ground or a separate ground. The light emitting diode 420 is configured to illuminate when the photoresistor(s) 114 sense light, indicating that the photosensor apparatus 110 is operational. The light emitting diode 420 may be a green light emitting diode and the resistor 416 may have a value of 470 ohms.

The resistor 418 is configured to be electrically connected to a base or gate of a transistor 422. The resistor 418 may have a value of 22 kilo-ohms, for example. An emitter or drain of the transistor 422 is connected to the same ground as the light emitting diode 420 and the capacitor 415 or a separate ground. Additionally, a collector or a source of the transistor 422 is electrically connected to an output end of the coil 408 of the relay 406. The collector or source of the transistor 422 may also be electrically connected to an anode of a diode 424, which is connected in parallel with the coil 408 of the relay 406. A cathode of the diode 424 is connected to the input end of the coil 408 and the first side (e.g., the input lead) of the photoresistor(s) 114.

During operation, the photoresistor(s) 114 do not allow current from the voltage source to pass when light is not detected. This causes the transistors 412 and 422 to prevent current flow to ground, thereby keeping the switch 410 of the relay 406 in the open state. In the open state, the signal line 120 does not have a signal, and thus there is no indication of a detected light of the indicator lamp 108. When light from the indicator lamp 108 is detected, a resistance of the photoresistor(s) 114 drops, which enables current to flow. The current causes the transistors 412 and 422 to activate or turn on. Further, the current causes the light emitting diode 420 to illuminate. Activation of the transistors 412 and 422 causes the switch 410 of the relay 406 to switch to a closed state, which causes a voltage to be applied to the signal line 120, thereby creating an alert or alarm signal for the monitoring system 122.

The light sensing circuit 115 of FIG. 4 is also configured to keep the switch 410 of the relay 406 in a closed state even during periodic flashes of light from the indicator lamp 108 of the laboratory instrument 102. In some instances, the processor 106 of the laboratory instrument 102 causes the amber/orange light 204 of the indicator lamp 108 to blink or flash. For example, the amber/orange light 204 may illuminate for 500 milliseconds and then turn off for 500 milliseconds. It should be appreciated that the rate of flashing may be between tens or hundreds of milliseconds to a few seconds or tens of seconds. Further, the duty cycle between on/off illumination may be between 10% and 90%.

The capacitor 415 in conjunction with the transistors 412 and 422 and the resistors 414, 416, and 418 are configured to provide a smoothing function that keeps the switch 410 of the relay 406 in the closed state even when the photoresistor(s) 114 are not detecting light between flashes. The capacitor 415 is configured to store charge that is dissipated when the photoresistor(s) 114 fail to detect light, thereby mirroring open circuits with respect to the voltage source. The current from the capacitor 415 is discharged through the gates or bases of the transistors 412 and 422 to keep the transistors 412 and 422 switched on. This enables a voltage from the voltage source to charge the coil 408 of the relay 406, keeping the switch 410 in the closed state to ensure that a continuous alert or alarm signal is provided on the signal line 120. The output switching times of the transistors 412 and 422 in conjunction with the resistors 416 and 418 ensure that current from the capacitor 415 is discharged at a slower rate, thereby keeping the switch 410 of the relay 406 switched to the closed state for a longer period of time, such as 500 milliseconds to a few seconds, corresponding to a period of time when the indicator lamp 108 is not illuminating the amber/orange light 204.

The limited discharge of the capacitor 415 ensures that the relay 406 is not switched closed when the indicator lamp 108 is turned off. When the capacitor 415 is fully discharged, the transistor 412 switches off, thereby switching off the transistor 422 and preventing current flow from the voltage source through the coil 408 of the relay 406. When this occurs, the switch 410 moves to the open state, which causes zero (or near zero) voltage to be applied to the signal line 120, indicating that there is no current alarm or alert condition.

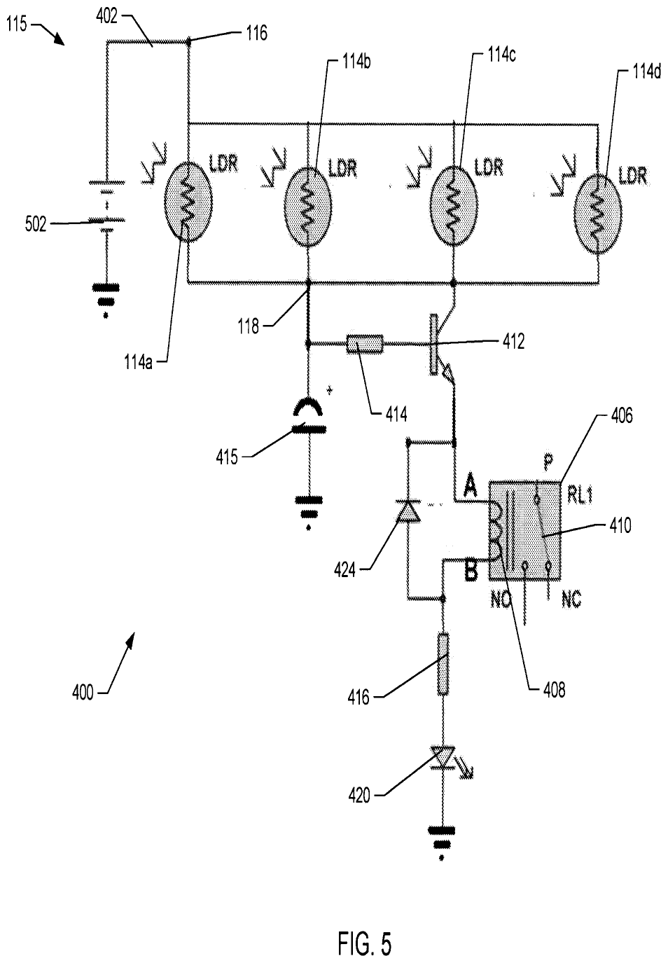

FIG. 5 is a diagram of an alternative embodiment of the light sensing circuit 115 of FIG. 4, according to an example embodiment of the present disclosure. In this example, the diode 404 is omitted. Additionally, a power source 502 is shown as a battery. However, the power source 502 may include an AC voltage source, as described in connection with FIG. 4. The embodiment of FIG. 5 also includes a single transistor 412, with transistor 422 of FIG. 4 omitted. In this embodiment, the input of the coil 408 of the relay 406 is electrically connected to the emitter or drain of the transistor 412.

Returning to FIG. 1, the monitoring system 122 may include any laptop computer, workstation, personal computer, server, tablet computer, smartphone, etc. The monitoring system 122 is communicatively coupled to the photosensor apparatus 110 via the signal line 120. In some embodiments, the signal line 120 may include a single wire, a dual wire, or a serial connection. The monitoring system 122 may include application 124 defined by machine-readable instructions that are stored on a memory device. A processor of the monitoring system 122 is configured to execute the instructions to perform the operations described herein.

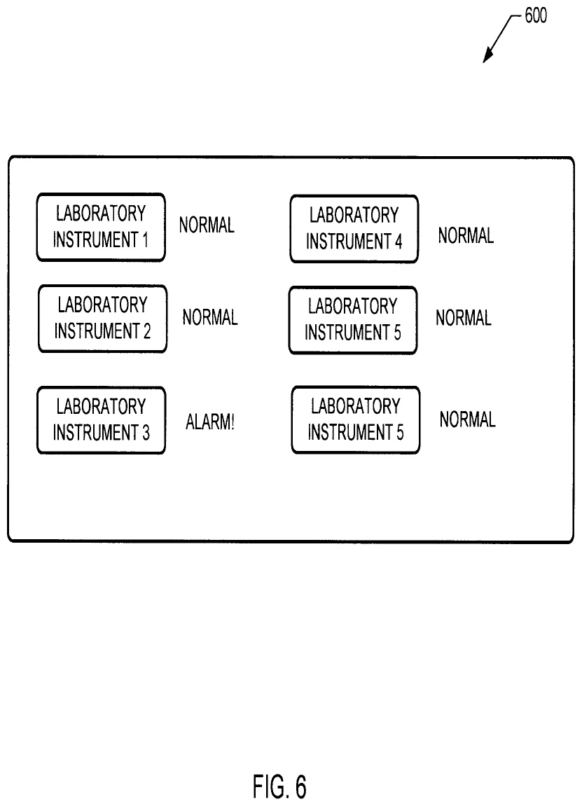

The application 124 is configured to display an indication of the alert and/or alarm received via the signal line 120. In some embodiments, the monitoring system 122 is connected to a plurality of photosensor apparatuses 110 via respective signal lines 120. Such a configuration provides for the concurrent monitoring of a plurality of laboratory instruments 102. Each signal line 120 is connected to a separate port or circuit board pin of the monitoring system 122. This configuration enables the monitoring system 122 to determine which laboratory instrument 102 activated its indicator light 108 based on which port/pin received an alarm/alert signal. Accordingly, the application 124 identifies which of the laboratory instruments 102 corresponds to the alarm/alert. The application 124 may display the alarm/alert in a user interface, such as the user interface 600 of FIG. 6. In the illustrated example, the user interface 600 shows that an amber/orange light of an indicator lamp of laboratory instrument 3 is illuminated.

Returning to FIG. 1, the monitoring system 122 may be communicatively coupled to a network 126 via wired or a wireless connection. The network 126 includes any cellular network (e.g., a 3G, 4G, and/or 5G wireless network), any wireless local area network (“WLAN”) such as Wi-Fi, and/or any wireless or wired wide area network (“WAN”) such as the Internet. In some embodiments, the network 126 may include combinations of different types of networks. For example, the network 126 may include a cellular network that is communicatively coupled to a WAN.

The network 126 is communicatively coupled to one or more client devices 128. The application 124 on the client device 128 is configured to display the alert/alarm status of the laboratory instrument(s) 102, as provided by the monitoring system 122. The client device 128 may include a memory device storing machine-readable instructions. A processor of the client device 128 is configured to execute the instructions to cause the application 124 to perform the operations described herein. In some embodiments, the application 128 is configured to receive status updates from the monitoring system 122, including indications as to when alert/alarm signals are received. The disclosed configuration enables an operator to remotely monitor the laboratory instrument(s) 102 using the application 124 that has received status updates from the monitoring system 122 when at least one operator is not present and in close proximity to the instrument(s) to monitor when an indicator light has been activated.

### Example Light Detection Procedure

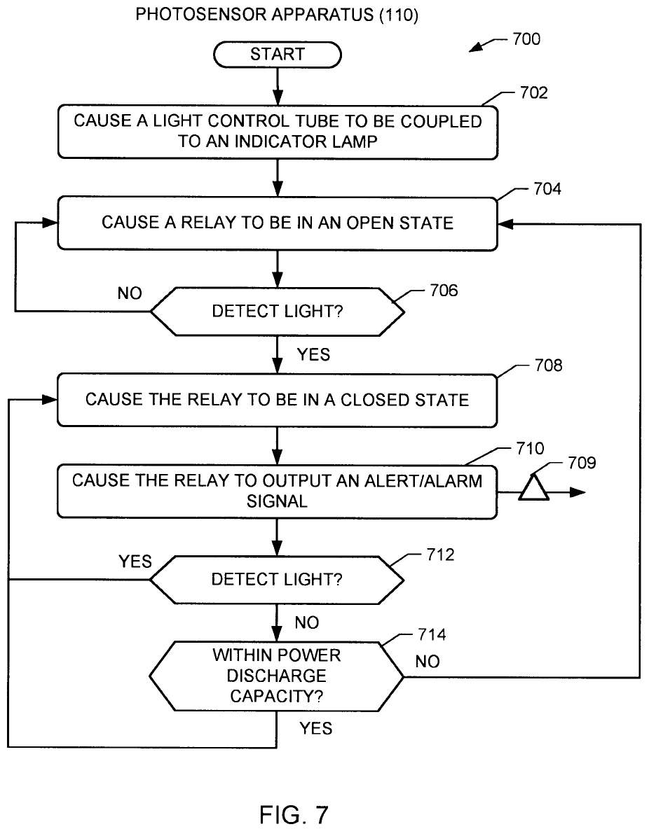

FIG. 7 illustrates a flow diagram showing an example procedure 700 for using the photosensor apparatus 110 to detect when a certain color light of the indicator light 108 of the laboratory instrument 102 is activated, according to an example embodiment of the present disclosure. Although the procedure 700 is described with reference to the flow diagram illustrated in FIG. 7, it should be appreciated that many other methods of performing the steps associated with the procedure 700 may be used. For example, the order of many of the blocks may be changed, certain blocks may be combined with other blocks, and many of the blocks described are optional. For example, the procedure 700 may include steps for transmitting indications of alert/alarms to client devices from the monitoring system 122. The actions described in procedure 700 may be performed among multiple devices including, but not limited to, the photosensor apparatuses 110 and the monitoring system 122.

The procedure 700 begins when the light control tube 112 of the photosensor apparatus 110 is coupled or placed adjacent to an indicator light 108 of a laboratory instrument 102 (block 702). At this point, the indicator light 108 is off and the photosensor apparatus 110 causes the relay 406 (or switch) of FIG. 4 or 5, to be placed into an open state (block 704). In this open state, an alert or alarm voltage signal is not provided on the signal line 120. The photosensor apparatus 110 next uses the photoresistor(s) 114 to detect when an amber/orange light of the indicator lamp 108 is illuminated (block 706). If the light 108 is not illuminated, the photosensor apparatus 110 keeps the relay 406 in the open state.

However, when light is detected, current flowing through the light sensing circuit 115 causes the relay 406 to switch to a closed state (block 708). Closing of the relay 406 causes a voltage to be applied to a signal line 120, which constitutes an alert/alarm signal 709 (block 710). As discussed above, the alert/alarm signal 709 is transmitted to the monitoring system 122 to provide an indication of a detected analyte, such as bacteria, located in a donated platelet sample. The photosensor apparatus 110 then determines via the photoresistor(s) 114 whether light is still detected (block 712). If light is still detected, the photosensor apparatus 110 causes the relay 406 to stay in the closed state to maintain the generation of the alert/alarm signal 709.

However, when light is no longer detected, the photosensor apparatus 110 determines if the light has been off for a duration that is shorter than a discharge voltage capacity of the capacitor 415 (and/or on/off state transitions of the transistors 412 and 422) (block 714). If the light has not been off for a duration that is shorter than the discharge voltage capacity of the capacitor 415, the photosensor apparatus 110 cause the relay 406 to stay in the closed state. However, when the light has been off for a duration that is longer than the discharge voltage capacity of the capacitor 415, the photosensor apparatus 110 causes the relay 406 to switch to the open state, thereby terminating the alert/alarm signal 709. The example procedure 700 continues until the photosensor apparatus 110 is powered off or removed from the indicator light 108 of the laboratory instrument(s) 102.

### CONCLUSION

It will be appreciated that all of the disclosed methods and procedures described herein can be implemented using one or more computer programs or components. These components may be provided as a series of computer instructions on any computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A photosensor apparatus comprising:
a voltage source;
a relay including:
a coil having an input end and an output end, and
a switch connected to the voltage source or a separate voltage source and configured to switch between an open state and a closed state;
at least one photoresistor or multiple photoresistors connected in parallel with each other, an input lead of each photoresistor being connected to the voltage source;
a first transistor including a first collector or a first source connected to output leads of the photoresistors, a first base or a first gate connected to a first resistor, which is connected to the output leads of the photoresistors, and a first emitter or a first drain that is connected to a second resistor and a third resistor;
a second transistor including a second collector or a second source connected to the output end of the relay coil, a second base or a second gate connected to the second resistor, and a second emitter or a second drain that is connected to a ground; and
a capacitor including a first end connected to the output leads of the photoresistors and a second end connected to the ground or a different ground,
wherein the photoresistors are configured to detect constant or flashing light from an indicator lamp of a laboratory instrument and the combination of the first transistor, the second transistor, and the capacitor are configured to cause the switch of the relay to stay in the closed state when the constant or flashing light is detected.

2. The apparatus of claim 1, wherein the relay is configured to output an alert signal in the closed state, the output signal being transmitted to a processor of a monitoring system, causing the processor to display an alert or an alarm to an operator.

3. The apparatus of claim 1, further comprising:
a circuit board including a power connector that is electrically connected to the voltage source, the relay, the first transistor, the second transistor, and the capacitor;
a first wire connected to the power connector via the circuit board and to the input lead(s) of the photoresistor(s); and
a second wire connected to a node at the circuit board and respectively to the output lead(s) of the photoresistor(s),
wherein the node at the circuit board is connected to the first collector or the first source of the first transistor and the first resistor.

4. The apparatus of claim 3, further comprising a light control tube configured to enclose at least portions of the first wire, at least portions of the second wire, and the photoresistor(s), the light control tube having an open end configured to be placed adjacent to the indicator light of the laboratory instrument for receiving the flashing or constant light.

5. The apparatus of claim 1, wherein an opposite end of the second resistor is connected to an anode of a light emitting diode, and wherein a cathode of the light emitting diode is connected to the ground or a separate ground.

6. The apparatus of claim 1, wherein a first diode is connected between the voltage source and the at least one photoresistor or multiple photoresistors, and
wherein an anode of a second diode is connected to the second collector or the second source of the second transistor and a cathode of the second diode is connected to the input end of the relay.

7. The apparatus of claim 1, wherein the capacitor is a polarized capacitor.

8. The apparatus of claim 1, wherein the voltage source is between 5 volts and 12 volts and the capacitor has a value of 1 k uF.

9. The apparatus of claim 1, wherein the first and second transistors are bipolar junction transistors (“BJTs”) or metal-oxide-semiconductor field-effect transistor (“MOSFETs”).

10. A photosensor apparatus comprising:
a switch connected to a voltage source, the switch having an input end and an output end and configured to switch between an open state and a closed state;
at least one photoresistor or multiple photoresistors connected in parallel with each other, an input lead of each photoresistor being connected to the voltage source;
a first transistor including a first collector or a first source connected to output leads of the photoresistors, a first base or a first gate connected to a first resistor, which is connected to the output leads of the photoresistors, and a first emitter or a first drain that is connected to at least a second resistor;
a second transistor including a second collector or a second source connected to the output end of the switch, a second base or a second gate connected to the second resistor, and a second emitter or a second drain that is connected to a ground; and
a capacitor including a first end connected to the output leads of the photoresistors and a second end connected to the ground or a different ground,
wherein the photoresistors are configured to detect constant or flashing light from an indicator lamp of a laboratory instrument and the combination of the first transistor, the second transistor, and the capacitor are configured to cause the switch to stay in the closed state when the constant or flashing light is detected.

11. The apparatus of claim 10, wherein the switch is configured to output an alert signal in the closed state, the output signal being transmitted to a processor of a monitoring system, causing the processor to display an alert or an alarm to an operator.

12. The apparatus of claim 10, wherein the laboratory instrument is configured to analyze platelets for bacteria and activate the indicator lamp, change an illuminated color of the indicator lamp, and/or cause the indicator lamp to flash when bacteria is detected.

13. The apparatus of claim 10, further comprising:
a circuit board including a power connector that is electrically connected to the voltage source, the switch, the first transistor, the second transistor, and the capacitor;
a first wire connected to the power connector via the circuit board and to the input lead(s) of the photoresistor(s); and
a second wire connected to a node at the circuit board and respectively to the output lead(s) of the photoresistor(s),
wherein the node at the circuit board is connected to the first collector or the first source of the first transistor and the first resistor.

14. The apparatus of claim 13, further comprising a light control tube configured to enclose at least portions of the first wire, at least portions of the second wire, and the photoresistor(s), the light control tube having an open end configured to be placed adjacent to the indicator light of the laboratory instrument for receiving the flashing or constant light.

15. The apparatus of claim 14, wherein the light control tube is mechanically coupled to the indicator light.

16. The apparatus of claim 10, wherein an opposite end of the second resistor is connected to an anode of a light emitting diode, and wherein a cathode of the light emitting diode is connected to the ground or a separate ground.

17. The apparatus of claim 10, wherein a first diode is connected between the voltage source and the at least one photoresistor or multiple photoresistors, and
wherein an anode of a second diode is connected to the second collector or the second source of the second transistor and a cathode of the second diode is connected to the input end of the switch.

18. The apparatus of claim 10, wherein the capacitor is a polarized capacitor.

19. The apparatus of claim 10, wherein the voltage source is between 5 volts and 12 volts and the capacitor has a value of 1 k uF.

20. The apparatus of claim 10, wherein the first and second transistors are bipolar junction transistors (“BJTs”) or metal-oxide-semiconductor field-effect transistor (“MOSFETs”).
